(19) United States
(12) Patent Application Publication
(10) Pub. No.: US 2025/0150369 A1
(43) Pub. Date: May 8, 2025

(54) INFORMATION PROCESSING DEVICE, INFORMATION PROCESSING METHOD, AND PROGRAM

(71) Applicant: Panasonic Intellectual Property Management Co., Ltd., Osaka (JP)

(72) Inventors: Hiroshi TAKAHASHI, Kanagawa (JP); Naganori SHIRAKATA, Osaka (JP); Takenori SAKAMOTO, Kanagawa (JP); Akihiro EGAMI, Tokyo (JP); Koji TAKINAMI, Kanagawa (JP)

(21) Appl. No.: 18/838,482

(22) PCT Filed: Oct. 6, 2022
(86) PCT No.: PCT/JP2022/037471

§ 371 Date: Aug. 14, 2024

(30) Foreign Application Priority Data
Feb. 25, 2022 (JP) 2022-027854

(51) Int. Cl. H04L 43/0852; H04L 41/22; H04L 43/55

(52) U.S. Cl. CPC H04L 43/0852; H04L 41/22; H04L 43/55

(57) ABSTRACT

This information processing device is provided with: a simulation circuit that, on the basis of the communication attribute of a first communication device, the transmission priority of the first communication device, and the reception priority of a second communication device, simulates a first delay characteristic between the first communication device and the second communication device that are connected; and a display that displays the first delay characteristic and a first delay threshold value corresponding to the first delay characteristic.

### TECHNICAL FIELD

The present disclosure relates to an information processing apparatus, an information processing method, and a program.

### BACKGROUND ART

As a technology for guaranteeing real-time communication between a plurality of Factory Automation (FA) apparatuses such as manufacturing devices and production lines, introduction of Time Sensitive Networking (TSN) based on Ethernet (registered trademark; hereafter omitted) has been studied.

Patent Literature (hereinafter referred to as “PTL”) 1 discloses a technology for estimating an arrival cycle of a packet by sampling the amount of packets and quantifying unevenness of the amount of the packets in order to adjust the opening and closing timing of each gate of a packet switch in a communication system with the packet switch that employs a Time Aware Shaper (TAS), which is one type of TSN.

### CITATION LIST

### Patent Literature

### PTL 1

Japanese Patent Application Laid-Open No. 2019-96932

### SUMMARY OF INVENTION

However, when introducing TSN into an industrial network, for example, cycles of a data signal and a control signal, such as a timing of acquiring data from a sensor or a timing of moving a motor, are fixed and unchanged or not changed frequently due to system specifications (control). Therefore, the benefits obtained by estimation of the cycle of a packet are limited. Meanwhile, in the industrial network into which TSN is introduced, as a network configuration (e.g., network topology) becomes complicated and the number of Programmable Logic Controllers (PLCs), actuators, sensors, and the like to be connected to the network thus increases, network performance may vary depending on a communication parameter or a TSN parameter in the network. This makes it difficult to determine whether the network performance satisfies a required level.

One non-limiting and exemplary embodiment of the present disclosure contributes to providing an information processing apparatus, an information processing method, and a program each capable of visualizing satisfiability of network performance through adjustment of a parameter, e.g., priority.

An information processing apparatus according to an exemplary embodiment of the present disclosure includes: simulation circuitry, which, in operation, performs simulation of a first delay characteristic between a first communication apparatus and a second communication apparatus that are connected, the simulation being based on a communication attribute of the first communication apparatus, a transmission priority of the first communication apparatus, and a reception priority of the second communication apparatus: and a display, which in operation, displays the first delay characteristic and a first delay threshold corresponding to the first delay characteristic.

An information processing method according to an exemplary embodiment of the present disclosure includes: performing simulation of a delay characteristic between a first communication apparatus and a second communication apparatus that are connected, the simulation being based on a communication attribute of the first communication apparatus, a transmission priority of the first communication apparatus, and a reception priority of the second communication apparatus; and displaying the delay characteristic and a delay threshold corresponding to the delay characteristic.

A program according to an exemplary embodiment of the present disclosure causes an information processing apparatus to perform processing comprising: performing simulation of a delay characteristic between a first communication apparatus and a second communication apparatus that are connected, the simulation being based on a communication attribute of the first communication apparatus, a transmission priority of the first communication apparatus, and a reception priority of the second communication apparatus, and displaying the delay characteristic and a delay threshold corresponding to the delay characteristic.

It should be noted that general or specific embodiments may be implemented as a system, an apparatus, a method, an integrated circuit, a computer program, a storage medium, or any selective combination thereof.

According to an exemplary embodiment of the present disclosure, a delay characteristic and a corresponding delay threshold between a first communication apparatus and a second communication apparatus that are connected are displayed. The delay characteristic is simulated based on a communication attribute of the first communication apparatus, a transmission priority of the first communication apparatus, and a reception priority of the second communication apparatus. This allows the delay characteristic and the corresponding delay threshold to be displayed in accordance with the parameters such as the communication attribute, the transmission priority, and the reception priority, thus visualizing satisfiability of network performance through parameter adjustment.

Additional benefits and advantages of the disclosed aspects will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating an exemplary parameter automatic adjustment system including a parameter automatic adjustment apparatus according to an embodiment of the present disclosure;

FIG. 2 is a block diagram illustrating an exemplary internal configuration of a parameter automatic adjuster according to the embodiment of the present disclosure:

FIG. 3 is a sequence diagram illustrating an exemplary operation of the parameter automatic adjustment system including the parameter automatic adjustment apparatus according to the embodiment of the present disclosure;

FIG. 4 is a flowchart describing an exemplary detailed operation of a program analyzer in step S301 indicated in FIG. 3;

FIG. 5 illustrates an exemplary screen layout in a User Interface (UI) according to the embodiment of the present disclosure;

FIG. 6A illustrates an exemplary screen transition in the UI in accordance with a user manipulation according to the embodiment of the present disclosure;

FIG. 6B illustrates another exemplary screen transition in the UI in accordance with the user manipulation according to the embodiment of the present disclosure;

FIG. 6C illustrates still another exemplary screen transition in the UI in accordance with the user manipulation according to the embodiment of the present disclosure; and

FIG. 7 illustrates an exemplary hardware configuration of a computer according to the embodiment of the present disclosure.

### DESCRIPTION OF EMBODIMENTS

Hereinafter, an embodiment of the present disclosure will be described in detail with reference to the accompanying drawings as appropriate. However, more detailed description than necessary may be omitted. For example, detailed descriptions of already well-known matters and repeated descriptions for substantially the same configuration may be omitted. This is to prevent the following description from becoming unnecessarily redundant and to facilitate understanding by those skilled in the art.

Note that, the accompanying drawings and the following description are provided so that those skilled in the art understand the present embodiment sufficiently, and are not intended to limit the subject matters recited in the claims.

### Embodiment 1

### [Parameter Automatic Adjustment System]

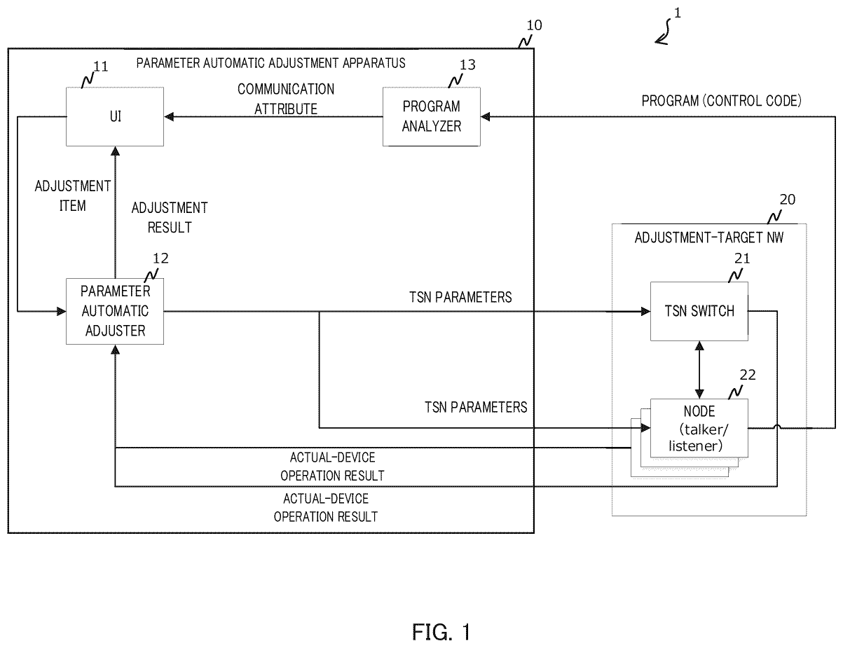

In FIG. 1, parameter automatic adjustment system 1 includes parameter automatic adjustment apparatus 10 and network to be adjusted (hereinafter referred to as adjustment-target NW) 20. Parameter automatic adjustment system I may be installed in order to, for example, manage various FA apparatuses connected to an industrial network in a production line or the like. A TSN switch and a node in adjustment-target NW 20 may be connected to each other via Ethernet, whereas parameter automatic adjustment apparatus 10 and adjustment-target NW 20 may be connected to each other by wire (e.g., Ethemet or the like) or by radio (e.g., WiFi (registered trademark), WiGig (registered trademark), WiMAX (registered trademark). or the like).

### [Parameter Automatic Adjustment Apparatus]

Parameter automatic adjustment apparatus 10 analyzes a program such as a PLC program (may also be referred to as control code, control program, and the like) read from adjustment-target NW 20 and extracts (acquires) a communication attribute from the program. Parameter automatic adjustment apparatus 10 then adjusts, based on the extracted communication attribute, TSN parameters (may also be referred to as control parameters) used by the TSN switch/node in adjustment-target NW 20 such that specifications required by, e.g., the production facility and production line are satisfied. The TSN parameters herein include, for example, an occurrence cycle (packet occurrence cycle), a length (packet length), and probability of occurrence (packet occurrence probability) of a packet transmitted by a talker. The TSN parameters may further include, for example, a priority of the talker (may also be referred to as transmission priority), a priority of a listener (may also be referred to as application priority or reception priority), and a required system delay. Parameter automatic adjustment apparatus 10 is an exemplary information processing apparatus according to the present disclosure.

Parameter automatic adjustment apparatus 10 includes user interface (UI) 11, parameter automatic adjuster 12, and program analyzer 13.

UI 11 may include, for example, at least one of a keyboard, a mouse, and a display (e.g., touchscreen or the like) (none of them is illustrated), and a UI controller (not illustrated). The UI controller may be realized by a general-purpose processing apparatus (processor) or control apparatus (controller), such as a Central Processing Unit (CPU), or a dedicated processing apparatus or control apparatus. Under the control of UI controller, UI 11 outputs (transmits) input information from a keyboard or the like manipulated by a user, to another component of parameter automatic adjustment apparatus 10, or displays the input information on a display. The user sets an adjustment item (e.g., communication attribute of node, priority of each node, priority of each application, required system delay, and the like) to be adjusted in the system via UI 11 (e.g., by manipulating UI 11). UI 11 outputs the set adjustment item to parameter automatic adjuster 12. Further, UI 11 (e.g., display) displays the communication attribute input from program analyzer 13, a logical connection relation between the talker and the listener, the adjustment result input from parameter automatic adjuster 12 (may also be referred to as adjustment status), and the like.

Parameter automatic adjuster 12 may be realized by a general-purpose processing apparatus or control apparatus, such as the CPU, or a dedicated processing apparatus or control apparatus. Parameter automatic adjuster 12 searches for TSN parameters based on the adjustment item input from UI 11. Parameter automatic adjuster 12 then outputs a search result that is candidate TSN parameters to adjustment-target NW 20 (TSN switch 21 and node 22). Further, parameter automatic adjuster 12 performs, based on the adjustment item input from UI 11, a search and optimization for/of the TSN parameters (determine combination of TSN parameters satisfying system delay), taking into account a model operation result (e.g., delay distribution to be described later) and an actual-device operation result (e.g., delay distribution to be described later), which will be described later. Parameter automatic adjuster 12 then outputs, to UI 11 (e.g., display), the adjustment result after the search and optimization. Parameter automatic adjuster 12 is an exemplary simulator according to the present disclosure. Parameter automatic adjuster 12 may also be referred to as a simulator, a learner, or the like.

Program analyzer 13 may be realized by a general-purpose processing apparatus or control apparatus, such as the CPU, or a dedicated processing apparatus or control apparatus. Program analyzer 13 analyzes a program that controls a PLC, a sensor, an actuator, a personal computer (PC), and the like which are included in node 22 of adjustment-target NW 20 to extract a communication attribute, network connection information, and the like from the program and then outputs the extracted communication attribute, network connection information, and the like to UI 11. Program analyzer 13 is an exemplary acquirer according to the present disclosure.

Program analyzer 13 analyzes a program such as the PLC program to extract, from the program, an occurrence cycle, a packet length of a packet, occurrence probability of the packet, and the like for each talker as the communication attribute. In addition, program analyzer 13 analyzes the program to extract, from the program, a logical connection relation between the talker and the listener, a logical connection relation between the node (talker or listener) and the TSN switch, and network topology.

The talker herein refers to a transmission node for the packet in TSN, and the listener refers to a reception node of the packet in TSN. For example, the sensor transmits a measured sensor value to, for example, the PLC, thus serving as the talker, whereas the actuator receives a control signal from, for example, the PLC, thus serving as the listener. The PLC serves as both the listener and talker because the PLC receives the sensor value from the sensor and transmits the control signal to the actuator or to another PLC. The talker is an exemplary communication apparatus (first communication apparatus) that performs transmission according to the present disclosure, and the listener is an exemplary communication apparatus (second communication apparatus) that performs reception according to the present disclosure.

### [Adjustment-Target Network]

Adjustment-target NW 20 includes actual devices of a TSN switch and a node to be adjusted by parameter automatic adjustment apparatus 10. Adjustment-target NW 20 operates based on TSN parameters that are adjusted (or determined) and provided by parameter automatic adjustment apparatus 10. Adjustment-target NW 20 outputs a result of such (actual-device) operation (hereinafter may also be referred to as “actual-device operation result”) to parameter automatic adjuster 12 of parameter automatic adjustment apparatus 10.

Adjustment-target NW 20 includes TSN switch 21 and node 22. TSN switch 21 is a network switch that implements a TSN function that specifies a protocol for transmitting data between systems via the Ethernet network. TSN may be provided with, for example, a time synchronization function that synchronizes the time in the entire network, an (access time guarantee) function that enables real-time data transmission, a scheduling (time setting) function, a gate control function, an interrupt function, and the like. TSN switch 21 may composed of one TSN switch or a plurality of TSN switches. TSN switch 21 (TSN switch included therein) operates based on TSN parameters that are adjusted (or determined) and provided by parameter automatic adjustment apparatus 10. TSN switch 21 (TSN switch included therein) then outputs a result of such (actual-device) operation to parameter automatic adjuster 12 of parameter automatic adjustment apparatus 10.

Node 22 refers to an FA apparatus such as a PLC, a sensor, an actuator, a PC, and the like included in adjustment-target NW 20. Node 22 may include, for example, one or a plurality of PLCs, sensors, actuators. PCs, and the like. Node 22 (FA apparatus included therein) operates based on TSN parameters that are adjusted (or determined) and provided by parameter automatic adjustment apparatus 10. Node 22 (FA apparatus included therein) then outputs a result of such (actual-device) operation to parameter automatic adjuster 12 of parameter automatic adjustment apparatus 10.

A control signal and a data signal are communicated between TSN switch 21 and node 22.

In this manner described above, parameter automatic adjustment apparatus 10 included in parameter automatic adjustment system 1 visualizes adjustment of the TSN parameters by presenting (e.g., displaying) the TSN parameters for which predetermined performance (e.g., system delay) has been acquired and the predetermined performance to a user and thus outputs the TSN parameters to adjustment-target NW 20 such that the adjusted TSN parameters are set for adjustment-target NW 20. Parameter automatic adjustment apparatus 10 may directly set the TSN parameters for adjustment-target NW 20.

Note that all of the plurality of illustrated functional blocks of parameter automatic adjustment apparatus 10 may be implemented in one apparatus or the plurality of functional blocks may be implemented in different apparatuses in a distributed manner.

### [Parameter Automatic Adjuster]

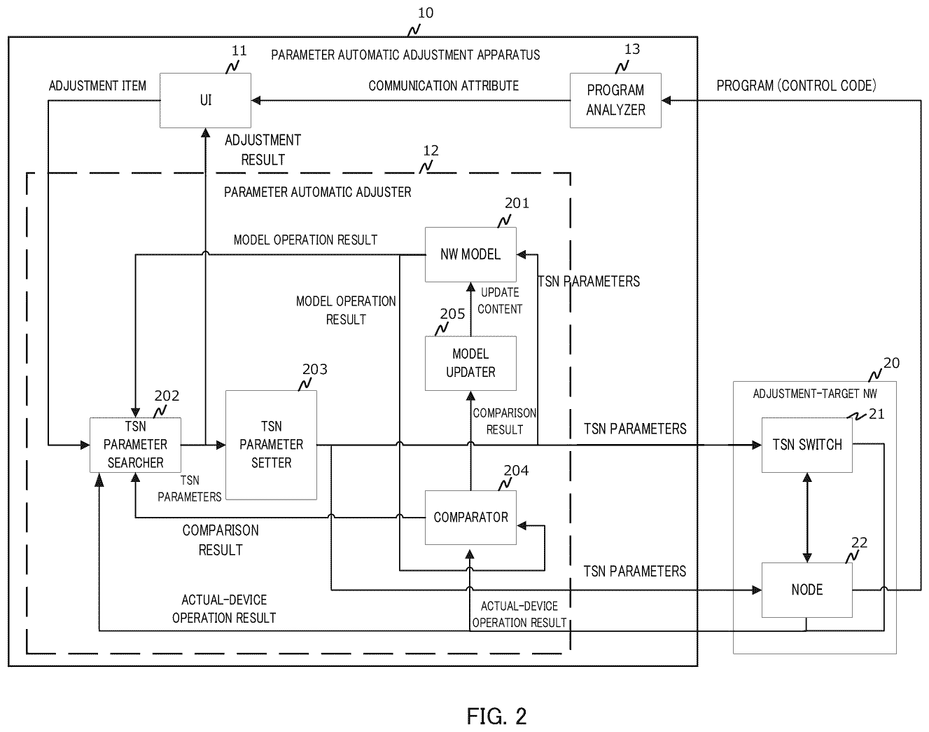

Parameter automatic adjuster 12 in FIG. 2 includes network (NW) model 201, TSN parameter searcher 202, TSN parameter setter 203, comparator 204, and model updater 205.

NW model 201, for example, constructs a NW model used for network simulation, by using network connection of adjustment-target NW 20 read from UI 11, information on the topology, information on a node to be connected, and the like. NW model 201 stores the constructed NW model in a storage (not illustrated) of NW model 201 or another storage in parameter automatic adjustment apparatus 10 (not illustrated). NW model 201 performs the network simulation based on the constructed NW model or a NW model updated by model updater 205 to be described later, and TSN parameters input from TSN parameter setter 203 to be described later. NW model 201 then outputs a result of the simulation (model operation result) to TSN parameter searcher 202 and comparator 204.

For the network simulation, NW model 201 defines, as delay time, a difference between the time when the talker starts packet transmission and the time when the listener starts packet reception, and determines (obtains) distribution of the delay time (may also be referred to as delay distribution) by repeatedly performing simulation of this delay time. The delay time and delay distribution are exemplary delay characteristics according to the present disclosure.

More specifically, for example, NW model 201 performs, based on the packet transmission cycle (occurrence cycle), the packet occurrence probability, and the packet length to be transmitted of each of a plurality of talkers, the simulation of the delay time such that the packet transmission from a talker with a high priority is preferred and the packet reception at a listener with a high priority is preferred. For example, when the packets transmitted by the plurality of talkers are partially or completely overlapping one another in time, NW model 201 assumes that the packets collide with one another. When the packets collide with one another, NW model 201 stops the transmission for a certain period of time for every talker in accordance with a predetermined rule (e.g., backoff), and retransmits the packet after the certain period of time (retransmission control). For this reason, occurrence of the collision of the packets lengthens the delay time. Further, when a network switch intervenes between the talker and the listener, the delay time occurs due to, for example, relay processing of a packet inside the network switch. NW model 201 determines the delay time and delay distribution, using the simulations and taking into account the collision and retransmission of the talker packets, a processing delay at a network switch, and the like.

TSN guarantees cycle transmission via the Ethernet by controlling a transmission queue, which is in accordance with a priority specified by a user, and a gate provided for each transmission queue. However, the priority has the upper limit of, e.g., eight, so that it is difficult to assign a specific priority to every node when the number of nodes to be controlled increases. Thus, no transmission timings are guaranteed for nodes assigned the same priority, and a plurality of nodes transmits packets within the transmission period allocated for the priority, which makes it difficult to satisfy the delay time required by the system.

Further, increases in the number of nodes and the number of TSN make it difficult to determine the opening/closing time of each gate, which is determined based on the occurrence packet length in addition to the priority, and the opening/closing cycle of the gate, which is determined based on the packet occurrence cycle, to fall within the delay time required by the system.

TSN parameter searcher 202 searches for a combination of TSN parameters based on the adjustment item input from UI 11, the actual-device operation results input from TSN switch 21 and node 22, and the model operation result input from NW model 201. TSN parameter searcher 202 then outputs a search result, that is, a candidate combination of the TSN parameters, to TSN parameter setter 203. Incidentally, TSN parameter searcher 202 may use, for searching, a learning model by machine-learning that predicts an actual-device operation result for the input parameter and then outputs the result or may use a hybrid model. that is a combination thereof. Various publicly known techniques are applicable for the machine learning, and, for example, deep learning that uses a neural network and generates a time series pattern can be used. Further, TSN parameter searcher 202 determines, based on the adjustment item input from UI 11, a combination of the TSN parameters that satisfies the system delay, taking into account the model operation result and the actual-device operation result. Parameter automatic adjuster 12 then outputs, to UI 11 (e.g., display), the adjustment result after the search and optimization. TSN parameter searcher 202 then outputs the adjustment result (e.g., delay distribution, information indicating whether required system delay (threshold) is satisfied, and the like) to UI 11 (e.g., display).

More specifically, for example, TSN parameter searcher 202 searches for the transmission period based on the priority for each talker so that the packet transmission from a talker with a high priority is preferred and the packet reception at a listener with a high priority is preferred. For every talker, TSN parameter searcher 202 searches for the opening/closing time of the gate for each priority so that the transmission period based on the packet length and the transmission cycle based on the packet length are satisfied for each talker and the packet reception at the listener with the high priority is preferred.

TSN parameter setter 203 outputs the TSN parameters to NW model 201, TSN switch 21, and node 22 such that the TSN parameters input from TSN parameter searcher 202 are set for NW model 201, TSN switch 21, and node 22. TSN parameter setter 203 may directly set the TSN parameters for NW model 201, TSN switch 21, and node 22.

Comparator 204 compares the actual-device operation result input from TSN switch 21 and node 22 with the model operation result input from NW model 201, and then outputs a comparison result to TSN parameter searcher 202 and model updater 205.

Model updater 205 determines whether to update the NW model held by NW model 201, based on the comparison result (actual-device operation result and model operation result) input from comparator 204. In a case where the NW model is updated to match the actual-device operation result as the result of the determination (e.g., when delay distribution of actual-device operation result and delay distribution of model operation result do not overlap each other), model updater 205 indicates (outputs) an updated content to NW model 201.

Incidentally, model updater 205 determines whether to update the NW model, and when updating the NW model, model updater 205 may indicate (output), to NW model 201, a content to be updated without performing the update. In this case, NW model 201 may update the NW model based on the content to be updated that has been indicated from model updater 205.

Further, other than the delay distribution, model updater 205 may update the NW model to match the actual-device operation result in a case where the processing time per TSN switch 21 and/or node 22 used in adjustment-target NW 20 differs between the actual-device operation result and the model operation result. Alternatively, model updater 205 may update the NW model to a value obtained by reading an operation clock and the amount of memory of a CPU installed in TSN switch 21 and/or node 22 from the actual machine.

### [Operation of Parameter Automatic Adjustment System]

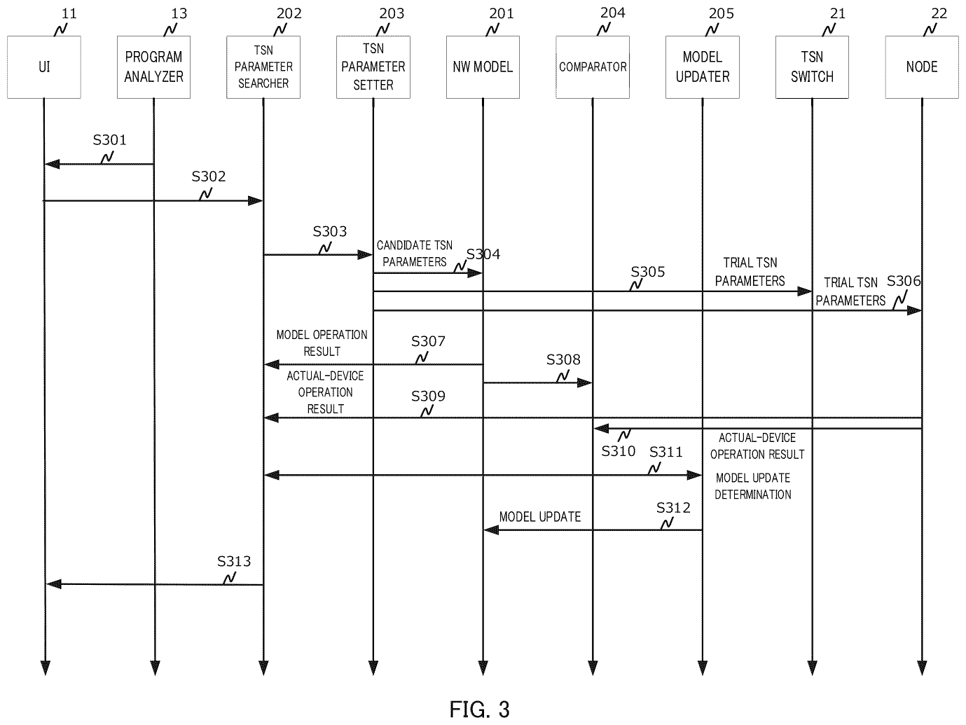

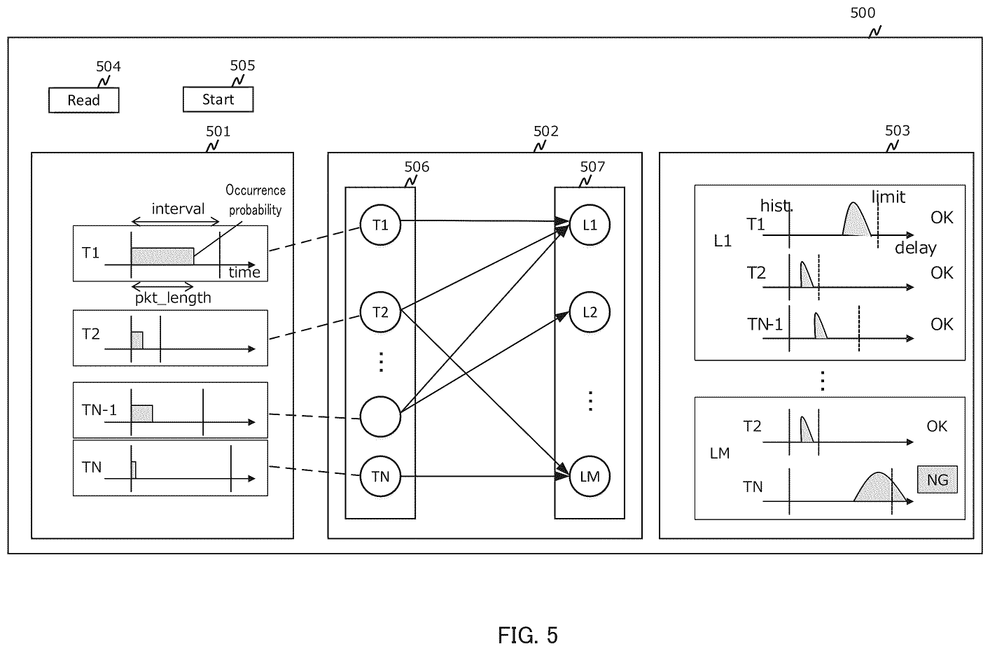

Although not illustrated in FIG. 3, the initiation of an operation of parameter automatic adjustment system 1 (step S301) may be triggered by a user such as input from the user (e.g., push down of read button 504 by user, which will be described later with reference to FIG. 5). Alternatively, the initiation of the operation of parameter automatic adjustment system 1 (step S301) may be triggered by introduction of adjustment-target NW 20 as a new network or by an update of adjustment-target NW 20 (e.g., addition or reduction of TSN switch or node with respect to adjustment-target NW 20).

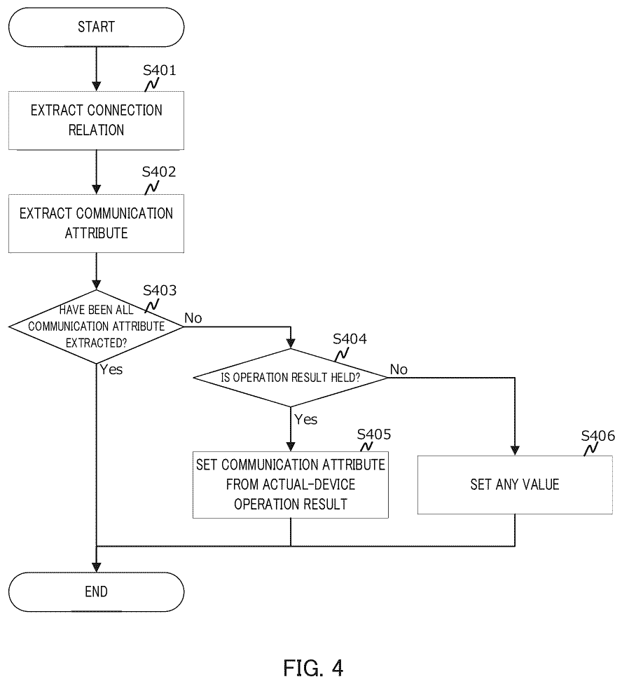

In step S301, program analyzer 13 analyzes a program such as a PLC program to extract, from the program, a communication attribute (packet length, packet occurrence cycle, packet occurrence probability, and the like) of a node (PLC, sensor, actuator. PC, and the like). In addition, in step S301, program analyzer 13 analyzes the program to extract, for example, a connection relation between nodes included in adjustment-target NW 20 (logical connection relation between talker and listener). In step S301, program analyzer 13 then outputs, to UI 11, the extracted communication attribute and connection relation between the nodes. Processing in step S301 will be described later with reference to FIG. 4.

In step S302, UI 11 outputs, to TSN parameter searcher 202, a communication attribute of the talker set by the user, priority settings of the talker and the listener, and system delay required by adjustment-target NW 20. Hereinafter, the communication attribute. priority setting, and system delay are collectively called a parameter.

In step S303, TSN parameter searcher 202 searches for TSN parameters based on the parameter input from UI 11 and then outputs the searched TSN parameters to TSN parameter setter 203.

In step S304, TSN parameter setter 203 outputs the TSN parameters to NW model 201 such that the TSN parameters input from TSN parameter searcher 202 are set for NW model 201 as candidate TSN parameters. TSN parameter setter 203 may directly set the TSN parameters for NW model 201.

In step S305 and step S306, respectively, TSN parameter setter 203 outputs, to TSN switch 21 and node 22, the TSN parameters input from TSN parameter searcher 202 such that the TSN parameters are set for TSN switch 21 and node 22 as trial TSN parameters. TSN parameter setter 203 may directly set the TSN parameters for TSN switch 21 and node 22

In step S307, NW model 201 simulates a model operation by using the set (candidate) TSN parameters and then outputs a model operation result, which is the simulation result, to TSN parameter searcher 202. In step S308, NW model 201 outputs the model operation result to comparator 204.

In step S309. TSN switch 21 and node 22 perform an actual-device operation by using the set (trial) TSN parameters and then output an actual-device operation result, which is the result of the actual-device operation, to TSN parameter searcher 202. Further, in step S310, TSN switch 21 and node 22 output the actual-device operation result to comparator 204.

In step S311, comparator 204 compares the model operation result input from NW model 201 with the actual-device operation result input from TSN switch 21 and node 22 and then outputs a comparison result to model updater 205 and TSN parameter searcher 202.

In step S312, model updater 205 updates, based on the comparison result input from comparator 204, a NW model to match the actual-device operation result and outputs an update content (may also be referred to as update result) to NW model 201.

In step S313, TSN parameter searcher 202 determines, based on the model operation result and the actual-device operation result, a combination of TSN parameters that satisfies the system delay and then outputs, to UI 11, the determined combination of the TSN parameters and the system delay (adjustment result described above).

TSN parameter searcher 202 may repeat the search of TSN parameters to satisfy the system delay (e.g., steps S303 to S312 may be performed repeatedly). TSN parameter searcher 202 may output the result to UI 11 even when the system delay is not satisfied. At least one of the number of searches and/or the search time by TSN parameter searcher 202 may be given, for example, by the user via UI 11.

Finally, after step S313, UI 11 presents (displays), to the user, the system delay obtained based on the search, the model operation result, and the actual-device operation result.

The order of the steps indicated in FIG. 3 may be changed appropriately as long as no contradiction occurs. For example, in step S308 prior to step S307, NW model 201 may simulate the model operation by using the set (candidate) TSN parameters and output, to comparator 204, the model operation result, which is the result of the simulation; thereafter, NW model 201 may output the model operation result to TSN parameter searcher 202 in step S307.

In step S401 of FIG. 4, program analyzer 13 analyzes the PLC program and the like read from the PLC and the like to extract, from the program, the connection relation between the talker and the listener in adjustment-target NW 20. Program analyzer 13 may extract the connection relation between the talker and the listener based on, for example, a connection drawing of the device (node) (drawing describing connection relation between device and network switch) and information on a port used in the program, which are stored in a storage (not illustrated) of parameter automatic adjustment apparatus 10 or a cloud (not illustrated).

In step S402, program analyzer 13 analyzes the PLC program read from the PLC and the like to extract the communication attribute from the program. For example, program analyzer 13 extracts a cycle time from the program and sets or determines the extracted cycle time as a transmission cycle of a packet (packet transmission cycle) to be transmitted by the talker. Note that, when a communication attribute defined by the program is present, program analyzer 13 may extract the defined information to set or determine as the communication attribute.

In step S403, program analyzer 13 checks whether all the communication attributes of the talker have been extracted. Program analyzer 13 terminates the processing when all the communication attributes of the talker are extracted (Yes in step S403). On the other hand, when a portion of the communication attributes of the talker has not been extracted (No in step S403), program analyzer 13 proceeds the processing to step S404.

In step S404, program analyzer 13 checks whether an actual-device operation result (e.g., transmission log and the like) is held in a storage (not illustrated) of program analyzer 13 or another storage (not illustrated) in parameter automatic adjustment apparatus 10. When the actual-device operation result is held (Yes in step S404), program analyzer 13 proceeds the processing to step S405. On the other hand, when the actual-device operation result is not held (No in step S404), program analyzer 13 proceeds the processing to step S406.

In step S405, program analyzer 13 sets a communication attribute acquired from the actual-device operation result and terminates the processing. For example, program analyzer 13 sets or determines, from the transmission log of the talker, all or a portion of the packet length, packet transmission cycle, and packet frequency as the communication attribute.

In step S406, program analyzer 13 sets any value as the communication attribute and terminates the processing. The any value may be selected at random by program analyzer 13 from, for example, a range of values or a plurality of values input by the user in advance.

### [Screen Layout]

Screen layout 500 in FIG. 5 includes talker-attribute setting screen 501, Input/Output (I/O) connection configuration screen 502, listener result (adjustment result) display screen 503, read button 504, search start (Start) button 505, transmission-priority setting screen 506, and application-priority setting screen 507. Herein, a description will be given assuming that adjustment-target NW 20 includes N talkers and M listeners.

Talker-attribute setting screen 501 displays the packet length (pkt_length), the packet occurrence cycle (interval), and the packet occurrence probability for each of the talkers (TI to TN illustrated in FIG. 5). For example, as illustrated in FIG. 5, talker-attribute setting screen 501 takes time on a horizontal axis, displays, along the horizontal axis, a packet length and an occurrence cycle of a talker, and displays probability of occurrence on a vertical axis as a bar graph.

Talker-attribute setting screen 501 may display not only the result of the program analysis by program analyzer 13, but also at least one of the packet length, the packet occurrence cycle, and the packet occurrence probability input by the user directly via UI 11. Meanwhile, the user may modify or change, via UI 11, the result displayed by talker-attribute setting screen 501. In a case where the user changes at least one of the packet length, the packet occurrence cycle, and the packet occurrence probability and thus presses search start button 505, the search is performed using the changed value.

I/O connection setting screen 502 displays logical connection relations between the talkers and the listeners (L1 to LM illustrated in FIG. 5) read by parameter automatic adjustment apparatus 10 (extracted by program analyzer 13). As an initial condition, the UI controller of UI 11 sets priorities in the order obtained by sorting with the packet occurrence probabilities of the respective talkers (setting priority of talker such that the higher the packet occurrence probability is, the higher the priority becomes), but the initial condition on a priority is not limited to this. In I/O connection setting screen 502 illustrated in the drawing, the higher the talker is displayed, the higher the priority is, but the relation between the display order and the priority is not limited to this example. Meanwhile, priorities of the listeners may be set in the order of identification numbers of the listeners or in the order of types of the listeners that are set in advance (e.g., in order of PLCs, actuators, and the like, and in random order or order of identification numbers and the like within same type), for example.

I/O connection setting screen 502 includes transmission-priority setting screen 506 and application-priority setting screen 507. In I/O connection setting screen 502, the logical connection relations between the talkers and the listeners may be uniquely determined from the program and displayed, for example, but transmission priorities (talker priorities) and application priorities (listener priorities) displayed on transmission-priority setting screen 506 and application-priority setting screen 507, respectively, may be set (changed) also by the user. When the user sets (changes) at least one of the transmission priorities and the application priorities by dragging and dropping, V/O connection setting screen 502 changes displaying on I/O connection setting screen 502 in accordance with this setting (change).

For example, in application-priority setting screen 507, the user can input and set, by dragging and dropping, a priority required from the application, in accordance with the priority such as a preference for a packet from the PLC, a camera, or the sensor. By way of example, in FIG. 5, L1, L2, and so forth, LM are displayed in this order, but the user can rearrange the order to L2, L1, and so forth, LM when wishing to give the highest priority to L2.

Listener-result display screen 503 displays, for each listener, whether the packets transmitted by the talkers satisfy the required system delay. The required system delay is an exemplary delay threshold according to the present disclosure.

Listener-result display screen 503 displays, for listener L1, for example, distribution of delay time (delay) of a packet transmitted by talker T1 on a horizontal axis and displays in a histogram (hist.) with a vertical axis. In this case, listener-result display screen 503 displays OK because the delay time required by the system (limit indicated by dotted line in FIG. 5) is satisfied. For listener LM, for example, listener-result display screen 503 displays NG (it is denoted as NG in the sense of “Not good”) because the delay distribution of the packet transmitted by talker TN does not satisfy the delay time required by the system. Incidentally, listener-result display screen 503 may display not only the delay distribution in the histogram but also may display statistical values such as the smallest and largest values of the delay time. Alternatively, instead of the delay time distribution, delay time obtained by one simulation may be compared with the delay time required by the system in order to determine whether the delay time by the one simulation satisfies the delay time required by the system.

When being is pressed, read button 504 starts reading the program such as the PLC program (analysis of program and extraction of communication attribute by program analyzer 13; step S301 illustrated in FIG. 3).

When being pressed, search start button 505 starts a search for TSN parameters using the set attribute information and priority (search by TSN parameter searcher 202: step S303 illustrated in FIG. 3).

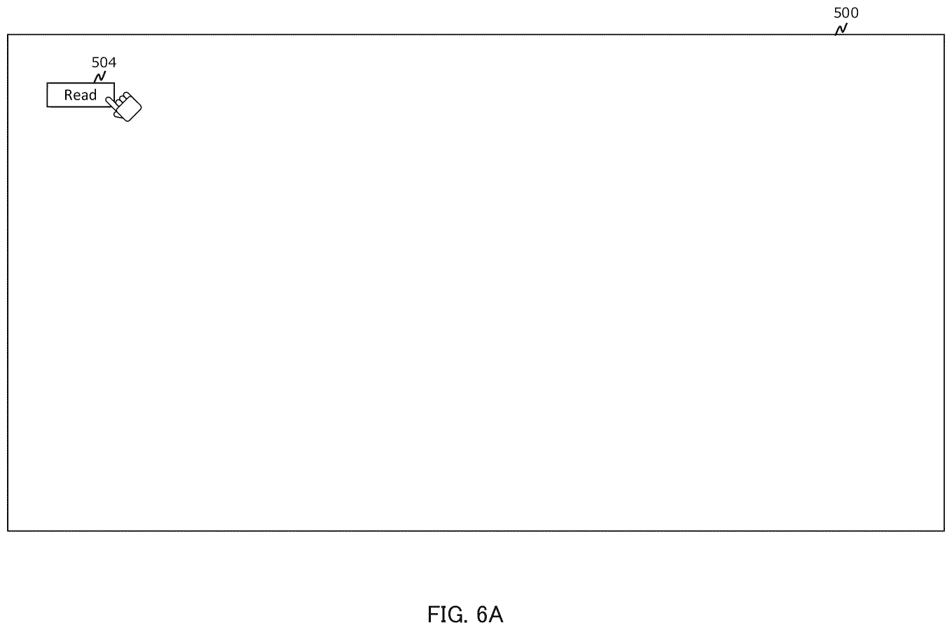

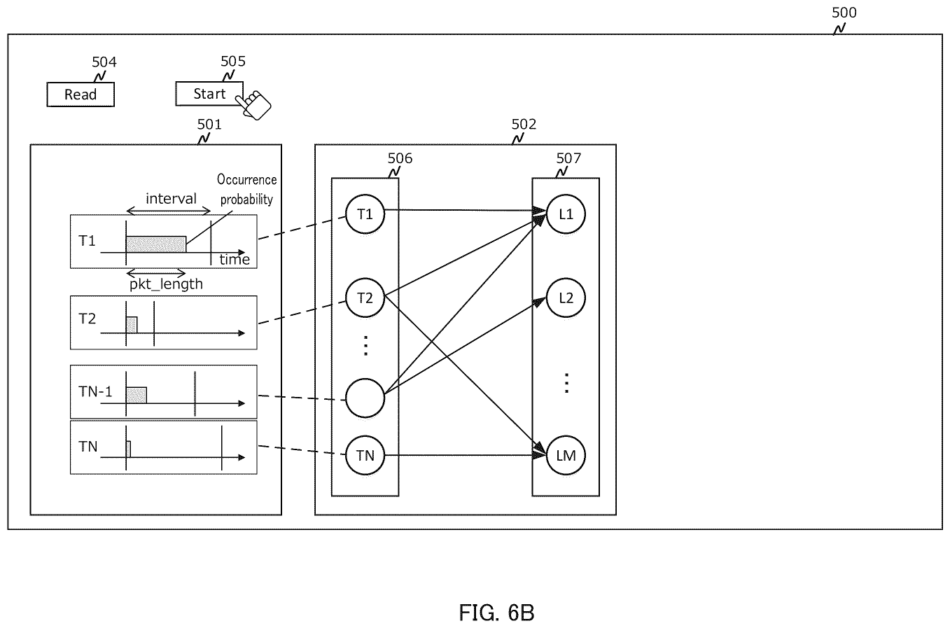

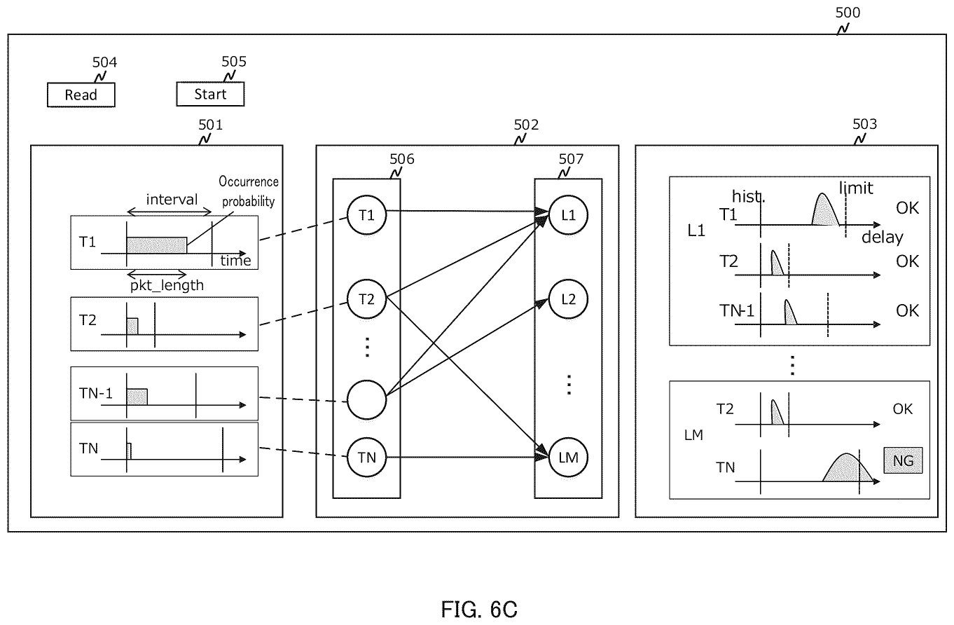

Next, a screen transitions in response to a user manipulation (input) for UI 11 will be described in time series with reference to FIGS. 6A to 6C.

In an initial state, read button 504 is displayed as illustrated in FIG. 6A.

When the user presses read button 504, parameter automatic adjustment apparatus analyzes the program to extract, from the program, the communication attributes of the 10 talkers and the logical connection relations between the talkers and the listeners, as described above. Then, as illustrated in 6B, parameter automatic adjustment apparatus 10 displays the communication attributes of the respective talkers on talker-attribute setting screen 501 and displays the logical connection relations between the talkers and the listeners in I/O connection setting screen 502. In addition, as illustrated in FIG. 6B, parameter automatic adjustment apparatus 10 displays search start button 505 as well. Thus, talker-attribute setting screen 501, I/O connection setting screen 502, and search start button 505 are further displayed at this stage.

Next, in transmission-priority setting screen 506 as needed, the user inputs and sets transmission priorities (priorities of talkers), and inputs and sets priorities of listeners in application-priority setting screen 507 in response to the priority required by the application.

When the user then presses search start button 505, parameter automatic adjustment apparatus 10 performs a search for TSN parameters as described above. Thus, as illustrated in FIG. 6C, parameter automatic adjustment apparatus 10 causes the adjustment result to be displayed on listener-result display screen 503. In this manner, listener-result display screen 503 is further displayed at this stage.

Next, the user looks at the result displayed on listener-result display screen 503, and then may reset (change) again a priority on application-priority setting screen 507 or change a communication attribute of a talker on talker-attribute setting screen 501, thereby performing the search for parameters again.

When the number of nodes increases or the required system delay time becomes shorter, it is difficult to satisfy all system delays regardless of how the parameters are searched. In such cases, the user may make a change in a part of the system that causes no problem (do not affect system) in terms of the system specifications (e.g., reduce priority of application, change occurrence cycle of packet, or the like) in order to search for usable TSN parameters that satisfy the system requirement. Generally, the increase in the number of nodes makes it difficult to search for the TSN parameters, and thus, it is hard for the user to know which TSN parameter to be changed. Therefore, using parameter automatic adjustment apparatus 10 in the embodiment of the present disclosure makes it possible to visualize a TSN parameter to be adjusted, thereby allowing the user to easily adjust the TSN parameter.

Incidentally, TSN has an interrupt function called frame pre-emption. When this frame pre-emption function is used, it is difficult to determine whether to interrupt with a talker having a short packet length or a talker having a long packet length. Even in such a case, since it is possible to, in talker transmission setting screen 401, for example, check the system delay at that time by dividing and shortening the packet length of talker T1, thereby significantly shortening and facilitating the adjustment work of the user.

### Variation

NW model 201 may acquire the information on the node that is to be connected to (to be included in) to adjustment-target NW 20 to be modeled (e.g., information on used CPU, CPU load rate, and memory, characteristics of communication device) and the information on the TSN switch, from the web or cloud (e.g., website of node manufacturer or the like). Additionally or alternatively, the user may input an evaluation result of the node and TSN switch via UI 11, for example. Thus, a more accurate NW model can be constructed which takes into account the characteristics of the node and TSN switch, thereby improving the model operation result.

When the TSN parameter search result indicates that it is difficult to satisfy the system specifications, parameter automatic adjuster 12 may simulate and evaluate system delay due to changing the network topology, system delay due to adding (or reducing) a TSN switch, or system delay due to performing both of them, and may then cause UI 11 (e.g., I/O connection setting screen 502) to display the changed topology information.

When system delay of a listener is satisfied. TSN parameter searcher 202 may suggest the upper limit value of the packet occurrence cycle or the like of the satisfied listener. TSN parameter searcher 202 outputs the upper limit value to UI 11, and talker-attribute setting screen 501 may display the upper limit value, for example.

TSN parameter searcher 202 may perform a search for a TSN parameter for a case where a certain PLC is replaced with another PLC, and determine the system delay at that time. TSN parameter searcher 202 may then output the parameter of the other PLC and the determined system delay to UI 11, and, for example, talker-attribute setting screen 501 may display a communication attribute for the other PLC, whereas listener-result display screen 503 may display the system delay.

When determining the model operation result, NW model 201 may set a CPU load rate of at least one of the node and TSN switch and thus determine the model operation result per CPU load rate. Performing the simulation taking into account, e.g., the CPU load rate, makes it possible to search for TSN parameters simulating an actual operation (e.g., when user controls sensor or actuator).

In the above, an example has been given in which the TSN parameters are searched based on the model operation result and the actual-device operation result, and the system delay at that time is displayed, but the actual-device operation result cannot be obtained in some cases. For example, it is difficult to obtain the actual-device operation result when the TSN parameters are determined in the designing stage of a production-line. In such a case, the TSN parameters may be searched based on the model operation result. In this case, the TSN parameters can be searched in an environment close to the actual device by generating the NW model and performing the simulation based on the information on the node (e.g., product number, used CPU, CPU load rate, information on memory) or based on the result of evaluation by the node alone.

In the above, an example has been given in which the transmission priority (talker priority) and the application priority (listener priority) displayed on transmission-priority setting screen 506 and application-priority setting screen 507, respectively, are changed by dragging and dropping, but the present disclosure is not limited to this example. For example, a box for displaying or inputting a priority may be provided next to displaying of each of the talker and the listener, and the transmission priority and the application priority may be changed by the user inputting a value or the like indicating the priority into the box and pressing a decision button, for example.

In the above, an example has been described in which listener-result display screen 503 is displayed as illustrated in FIG. 6C after the user presses search start button 505, but the present disclosure is not limited to this example. For example, after the user presses read button 504 in FIG. 6A, a search may be performed using, for example, an initial condition in which transmission priorities are set in the order of sorting with the packet occurrence probabilities of the respective talkers, and thus, a screen as illustrated in FIG. 6C may be displayed without displaying the screen as illustrated in FIG. 6B. Thereafter, the user may change at least one of the communication attribute and the priority and press search start button 505 to display another screen as illustrated in FIG. 6C.

In the embodiment described above, the term such as “part” or “portion” or the term ending with a suffix such as “-er” “-or” or “-ar” may be replaced with another term, such as “circuit (circuitry),” “assembly,” “device,” “unit,” or “module.”

Although the embodiment of the present disclosure has been described in detail with reference to the drawings, the functions of parameter automatic adjustment apparatus 10 mentioned above may be realized by a computer program.

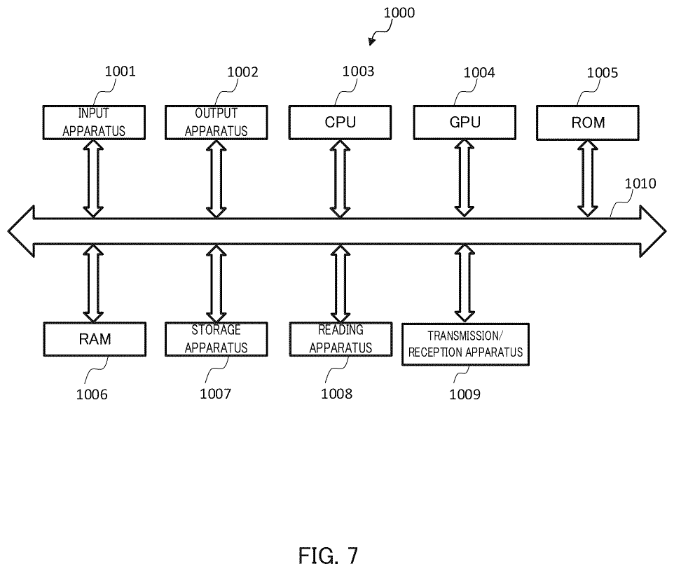

FIG. 7 illustrates a hardware configuration of computer 1000 that realizes the functions of parameter automatic adjustment apparatus 10 with a program. This computer 1000 includes input apparatus 1001 such as a keyboard, a mouse, and/or a touchpad, output apparatus 1002 such as a display and/or a speaker, central processing unit (CPU) 1003, graphics processing unit (GPU) 1004, read-only memory (ROM) 1005, random-access memory (RAM) 1006, storage apparatus 1007 such as a hard disk device and/or a solid state drive (SSD), reading apparatus 1008 that reads information from a recording medium such as a digital versatile disk read-only memory (DVD-ROM) and/or a universal serial bus (USB) memory, and transmission/reception apparatus 1009 that performs communication over network. These apparatuses 1001 to 1009 are connected to one another through bus 1010.

Reading apparatus 1008 reads a program for realizing the functions of parameter automatic adjustment apparatus 10 from a recording medium storing the program and stores the program in storage apparatus 1007. Altematively, transmission/reception apparatus 1009 communicates with a server apparatus connected to the network and stores, in storage apparatus 1007, a program for realizing the functions of parameter automatic adjustment apparatus 10 downloaded from the server apparatus.

CPU 1003 then copies the program stored in storage apparatus 1007 to RAM 1006, sequentially reads commands included in the program from RAM 1006, and performs the commands to realize the functions of parameter automatic adjustment apparatus 10.

### Effect of Embodiment

Parameter automatic adjuster 12 of parameter automatic adjustment apparatus 10 simulates delay time or delay distribution between a talker and a listener that are connected, based on a communication attribute of the talker (packet occurrence cycle, packet length, and packet occurrence probability), a talker priority, and a listener priority. UI 11 of parameter automatic adjustment apparatus 10 displays the simulated delay time or delay distribution and a corresponding required system delay.

With the above-described configuration, the delay time or delay distribution between the talker and the listener that is simulated based on the communication attribute of the talker, the talker priority, and the listener priority, and the corresponding required system delay are displayed. This allows the delay time or delay distribution and the corresponding required system delay to be displayed in accordance with the parameters such as the communication attribute, the talker priority, and the listener priority, thus visualizing satisfiability of network performance through the parameter adjustment.

### Summary of Embodiment

An information processing apparatus (parameter automatic adjustment apparatus 10) according to an embodiment of the present disclosure includes: simulation circuitry (parameter automatic adjuster 12), which, in operation, performs simulation of a first delay characteristic (delay time and delay distribution) between a first communication apparatus (talker included in node 22) and a second communication apparatus (listener included in node 22) that are connected, the simulation being based on a communication attribute (packet occurrence cycle, packet length, and packet occurrence probability) of the first communication apparatus, a transmission priority of the first communication apparatus (talker priority), and a reception priority of the second communication apparatus (listener priority or application priority); and a display (UI 11), which in operation, displays the first delay characteristic and a first delay threshold (required system delay) corresponding to the first delay characteristic.

With the above-described configuration, the first delay characteristic between the connected first communication apparatus and the second communication apparatus that is simulated based on the communication attribute of the first communication apparatus, the transmission priority of the first communication apparatus, and the reception priority of the second communication apparatus, and the corresponding first delay threshold can be displayed. This allows the first delay characteristic and the corresponding first delay threshold to be displayed in accordance with the parameters such as the communication attribute, the transmission priority, and the reception priority, thus visualizing satisfiability of network performance through parameter adjustment.

In the information processing apparatus, the simulation circuitry repeatedly determines, by simulation, a difference between time when the first communication apparatus starts transmission of a packet and time when the second apparatus starts reception of the packet, and thus determines distribution of the difference (delay distribution) as the first delay characteristic.

With the above-described configuration. it is possible to improve the accuracy of the first delay characteristic determined by the simulation.

In the information processing apparatus, the simulation circuitry performs, in a case where at least one of the communication attribute, the transmission priority, and/or the reception priority is changed, simulation of a second delay characteristic between the first communication apparatus and the second communication apparatus that are connected, the simulation being based on the at least one of the communication attribute, the transmission priority, and/or the reception priority that has been changed, and the display displays the second delay characteristic (delay time and delay distribution) and a second delay threshold (required system delay) corresponding to the second delay characteristic.

With the above-described configuration, the second delay characteristic and the corresponding second delay threshold can be displayed in accordance with the change in the parameters such as the communication attribute, the transmission priority, and the reception priority, thus visualizing satisfiability of network performance through the parameter adjustment.

In the information processing apparatus, as an initial condition, the transmission priority is set higher as a probability of occurrence of a packet transmitted by the first communication apparatus is higher.

With the above-described configuration, the delay characteristic and the corresponding delay threshold can be displayed assuming that the priority of the first communication apparatus that transmits a packet with a high probability of frequent occurrence.

In the information processing apparatus, the display includes: transmission-priority setting circuitry for changing the transmission priority; and reception-priority setting circuitry for changing the reception priority.

The above-described configuration allows, for example, a user to change and set the transmission priority and the reception priority via each of the transmission-priority setting circuitry and the reception-priority setting circuitry.

The information processing apparatus further includes acquisition circuitry (program analyzer 13), which, in operation, acquires, from a program that controls the first communication apparatus and the second communication apparatus, the communication attribute and a connection relation between the first communication apparatus and the second communication apparatus.

The above-described configuration makes it possible to grasp the current status of communication in the network.

An information processing method according to an embodiment of the present disclosure includes: performing simulation of a delay characteristic (delay time and delay distribution) between a first communication apparatus (talker included in node 22) and a second communication apparatus (listener included in node 22) that are connected, the simulation being based on a communication attribute (packet occurrence cycle, packet length, and packet occurrence probability) of the first communication apparatus, a transmission priority of the first communication apparatus (talker priority), and a reception priority of the second communication apparatus (listener priority or application priority); and displaying the delay characteristic and a delay threshold (required system delay) corresponding to the delay characteristic.

With the above-described configuration, a delay characteristic between the connected first communication apparatus and the second communication apparatus that is simulated based on the communication attribute of the first communication apparatus, the transmission priority of the first communication apparatus, and the reception priority of the second communication apparatus, and a corresponding delay threshold can be displayed. This allows the delay characteristic and the corresponding delay threshold to be displayed in accordance with the parameters such as the communication attribute, the transmission priority, and the reception priority, thus visualizing satisfiability of network performance through parameter adjustment.

A program according to an embodiment of the present disclosure causes an information processing apparatus (parameter automatic adjustment apparatus 10) to perform processing including: performing simulation of a delay characteristic (delay time and delay distribution) between a first communication apparatus (talker included in node 22) and a second communication apparatus (listener included in node 22) that are connected, the simulation being based on a communication attribute (packet occurrence cycle, packet length, and packet occurrence probability) of the first communication apparatus, a transmission priority of the first communication apparatus (talker priority), and a reception priority of the second communication apparatus (listener priority or application priority): and displaying the delay characteristic and a delay threshold (required system delay) corresponding to the delay characteristic.

With the above-described configuration, a delay characteristic between the connected first communication apparatus and the second communication apparatus that is simulated based on the communication attribute of the first communication apparatus, the transmission priority of the first communication apparatus, and the reception priority of the second communication apparatus, and the corresponding delay threshold can be displayed. This allows the delay characteristic and the corresponding delay threshold to be displayed in accordance with the parameters such as the communication attribute, the transmission priority, and the reception priority, thus visualizing satisfiability of network performance through parameter adjustment.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI. a super LSI, or an ultra LSI depending on a difference in the degree of integration. However, the technique of implementing an integrated circuit is not limited to the

LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being less-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples. Although the embodiment has been described above with reference to the drawings.

it is needless to say that the present disclosure is not limited to such example. It is apparent to those skilled in the art may arrive at various modifications or variations at within the scope of the claims, and it is naturally understood that they are also within the technical scope of the present disclosure. In addition, any combination of component elements in the above-mentioned embodiment may be made without departure from the spirit of the present disclosure.

The specific examples of the present disclosure have been described in detail above, but these specific examples are mere examples and do not limit the appended claims. The technology described in the appended claims embraces various modifications and changes made in accordance with the specific examples described above.

The disclosure of Japanese Patent Application No. 2022-027854, filed on February 25, 2022, including the specification, drawings and abstract, is incorporated herein by reference in its entirety.

### INDUSTRIAL APPLICABILITY

An exemplary embodiment of the present disclosure is useful in a technology for adjustment of network to which TSN is introduced.

### REFERENCE SIGNS LIST

1 Parameter automatic adjustment system
10 Parameter automatic adjustment apparatus
11 UI
12 Parameter automatic adjuster
13 Program analyzer
20 Adjustment-target NW
21 TSN switch
22 Node
201 NW model
202 TSN parameter searcher
203 TSN parameter setter
204 Comparator
205 Model updater

1. An information processing apparatus, comprising:
simulation circuitry, which, in operation, performs simulation of a first delay characteristic between a first communication apparatus and a second communication apparatus that are connected, the simulation being based on a communication attribute of the first communication apparatus, a transmission priority of the first communication apparatus, and a reception priority of the second communication apparatus; and
a display, which in operation, displays the first delay characteristic and a first delay threshold corresponding to the first delay characteristic.

2. The information processing apparatus according to claim 1, wherein the simulation circuitry repeatedly determines, by simulation, a difference between time when the first communication apparatus starts transmission of a packet and time when the second apparatus starts reception of the packet, and thus determines distribution of the difference as the first delay characteristic.

3. The information processing apparatus according to claim 1, wherein:
the simulation circuitry performs, in a case where at least one of the communication attribute, the transmission priority, and/or the reception priority is changed, simulation of a second delay characteristic between the first communication apparatus and the second communication apparatus that are connected, the simulation being based on the at least one of the communication attribute, the transmission priority, and/or the reception priority that has been changed, and
the display displays the second delay characteristic and a second delay threshold corresponding to the second delay characteristic.

4. The information processing apparatus according to claim 1, wherein, as an initial condition, the transmission priority is set higher as a probability of occurrence of a packet transmitted by the first communication apparatus is higher.

5. The information processing apparatus according to claim 1, wherein the display includes: transmission-priority setting circuitry for changing the transmission priority: and reception-priority setting circuitry for changing the reception priority.

6. The information processing apparatus according to claim 1, further comprising acquisition circuitry, which, in operation, acquires, from a program that controls the first communication apparatus and the second communication apparatus, the communication attribute and a connection relation between the first communication apparatus and the second communication apparatus.

7. An information processing method, comprising:
performing simulation of a delay characteristic between a first communication apparatus and a second communication apparatus that are connected, the simulation being based on a communication attribute of the first communication apparatus, a transmission priority of the first communication apparatus, and a reception priority of the second communication apparatus: and
displaying the delay characteristic and a delay threshold corresponding to the delay characteristic.

8. A program, causing an information processing apparatus to perform processing comprising:
performing simulation of a delay characteristic between a first communication apparatus and a second communication apparatus that are connected, the simulation being based on a communication attribute of the first communication apparatus, a transmission priority of the first communication apparatus, and a reception priority of the second communication apparatus; and
displaying the delay characteristic and a delay threshold corresponding to the delay characteristic.
